(19) United States
(12) Patent Application Publication
(10) Pub. No.: US 2017/0024009 A1
(43) Pub. Date: Jan. 26, 2017

(54) MOBILE DEVICE AND CONTROL METHOD THEREOF

(71) Applicant: HTC Corporation, Taoyuan City (TW)

(72) Inventors: Yu-Hsin Liang, Taoyuan City (TW); Shih-Hung Chu, Taoyuan City (TW); Heng-Chien Wu, Taoyuan City (TW)

(21) Appl. No.: 14/804,350

(22) Filed: Jul. 21, 2015

(51) Int. Cl. G06F 3/01; G06F 3/041; G06F 3/042

(52) U.S. Cl. CPC G06F 3/015; G06F 3/042; G06F 3/0416; G06F 2203/04106

(57) ABSTRACT

A mobile device and control method thereof are provided. The mobile device includes a life sensor, a driver, a touch detector, a heartbeat detector, a controller and a processor. The controller controls the driver to send a first driving signal. The life sensor generates a first sensing signal in response to the first driving signal. The touch detector determines whether the mobile device is touched according to the first sensing signal. When the touch detector determines that the mobile device is touched, the controller controls the driver to send a second driving signal. The life sensor generates a second sensing signal in response to the second driving signal. The heartbeat detector determines whether the second sensing signal includes a heartbeat pattern. The processor executes a corresponding operation according to whether the second sensing signal includes the heartbeat pattern.

### BACKGROUND

Technical Field

The invention relates to a mobile device. Particularly, the invention relates to a control method of the mobile device.

Related Art

Capacitive touch sensor is an important component in today's mobile devices. The capacitive touch sensors have various different areas. The large area capacitive touch sensors can be used for manufacturing a touch display. The small area capacitive touch sensors can be used for manufacturing touch keys to replace conventional mechanical keys.

However, the capacitive touch sensor has some disadvantages, for example, high price, high power consumption, and complicate design. When the capacitive touch sensor is close to a metal object, the mobile device probably misjudges a touch of the metal object as a touch operation of a user to cause a wrong reaction.

### SUMMARY

The invention is directed to a mobile device and a control method thereof for replacing a conventional capacitive touch sensor and accurately detecting user's touch operation or holding activity.

The invention provides a mobile device including a life sensor, a driver, a touch detector, a heartbeat detector, a controller and a processor. The driver is coupled to the life sensor. The touch detector is coupled to the life sensor and the driver. The heartbeat detector is coupled to the life sensor and the driver. The controller is coupled to the touch detector and the heartbeat detector, and controls the driver to send a first driving signal. The life sensor generates a first sensing signal in response to the first driving signal. The touch detector determines whether the mobile device is touched according to the first sensing signal. When the touch detector determines that the mobile device is touched, the controller controls the driver to send a second driving signal. The life sensor generates a second sensing signal in response to the second driving signal. The heartbeat detector determines whether the second sensing signal includes a heartbeat pattern. The processor is coupled to the controller, and executes a corresponding operation according to whether the second sensing signal includes the heartbeat pattern.

The invention provides a control method adapted to a mobile device, which includes following steps. A first driving signal is sent. A first sensing signal is generated in response to the first driving signal. It is determined whether the mobile device is touched according to the first sensing signal. When the mobile device is touched, a second driving signal is sent. A second sensing signal is generated in response to the second driving signal. It is determined whether the second sensing signal includes a heartbeat pattern. A corresponding operation is executed according to whether the second sensing signal includes the heartbeat pattern.

According to the above description, the mobile device and the control method thereof can correctly detect whether the user touches the mobile device and execute the corresponding operation, such that the mobile device can be more intelligent and user-friendly. The technique of the invention can also replace the touch keys implemented based on the capacitive touch sensors, so as to avoid the disadvantages of the capacitive touch sensor.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a mobile device according to an embodiment of the invention.

FIG. 2 is a flowchart illustrating a control method of a mobile device according to an embodiment of the invention.

FIG. 3 is a waveform diagram of two driving signals according to an embodiment of the invention.

### DETAILED DESCRIPTION OF DISCLOSED EMBODIMENTS

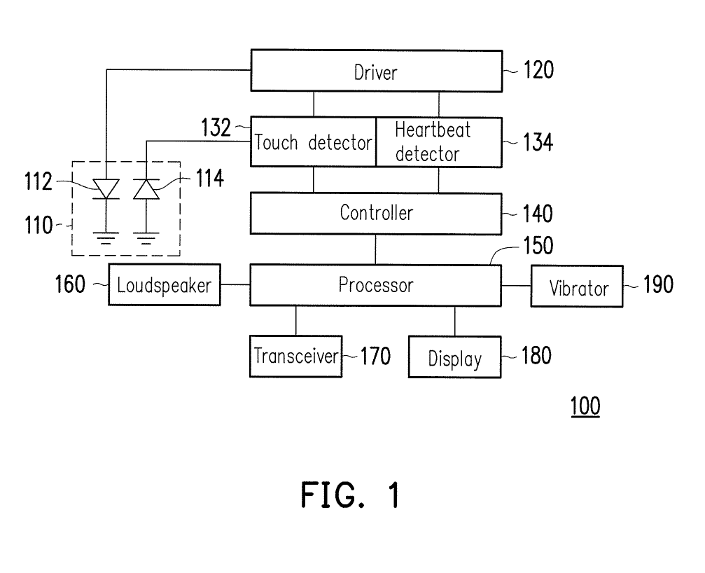

FIG. 1 is a schematic diagram of a mobile device 100 according to an embodiment of the invention. The mobile device 100 can be a smart phone, a personal digital assistant (PDA) or a tablet personal computer (PC). The mobile device 100 includes a life sensor 110, a driver 120, a touch detector 132, a heartbeat detector 134, a controller 140, a processor 150, a loudspeaker 160, a transceiver 170, a display 180 and a vibrator 190. The life sensor 110 includes a light-emitting diode (LED) 112 and a photodiode 114. The driver 120 is coupled to the LED 112. The touch detector 132 is coupled to the photodiode 114 and the driver 120. The heartbeat detector 134 is also coupled to the photodiode 114 and the driver 120. The controller 140 is coupled to the touch detector 132 and the heartbeat detector 134. The processor 150 is coupled to the controller 140, the loudspeaker 160, the transceiver 170, the display 180 and the vibrator 190.

The life sensor 110 can detector whether a user touches or holds the mobile device 100. The life sensor 110 can be disposed at any position of the mobile device 100. For example, the life sensor 110 can be disposed at a position that is easy to be touched by the user when the user holds the mobile device 100, for example, under a power key or a volume key. The life sensor 110 can also be disposed under a casing of the mobile device 100. In the mobile device 100, the key or the casing corresponding to the position of the life sensor 110 can be fabricated by using a transparent material, so as to facilitate a light signal emitted by the LED 112 and a reflected signal thereof to pass there through.

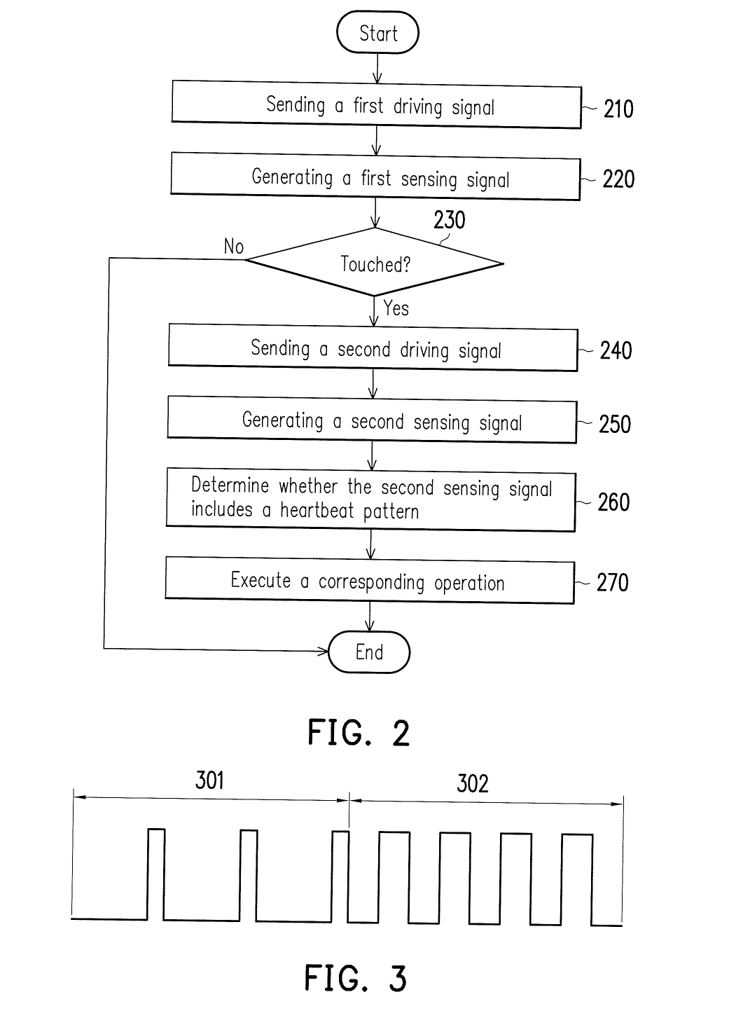

The life sensor 110, the driver 120, the touch detector 132, the heartbeat detector 134, the controller 140 and the processor 150 can execute a control method shown in FIG. 2, which is described in detail later. The loudspeaker 160 can be used for playing music or sending a sound prompt when the mobile device 100 receives an incoming call or a message. The vibrator 190 can send a vibration prompt when the mobile device 100 receives an incoming call or a message. The mobile device 100 can be connected to a wireless communication network or peripheral equipment such as a smart watch, etc., through the transceiver 170 and a wireless transmission specification such as Wi-Fi, bluetooth, 3G or 4G, etc. The display 180 can display a user interface of the mobile device 100 and receive a touch operation.

FIG. 2 is a flowchart illustrating a control method of a mobile device according to an embodiment of the invention. The control method can be periodically executed by the mobile device 100. In step 210, the controller 140 activates the touch detector 132. The touch detector 132 controls the driver 120 to send a first driving signal when being activated. In step 220, the life sensor 110 generates a first sensing signal in response to the first driving signal. To be specific, the LED 112 emits a first light signal in response to the first driving signal. The first light signal can be a red light or an infrared light. If an object touches the mobile device 100 at the position where the life sensor 110 is located, the object reflects the first light signal. The photodiode 114 receive a reflected signal of the first light signal, and generates the first sensing signal according to the reflected signal.

The first sensing signal is not necessarily produced based on the reflection caused by the touch of the object. The first sensing signal can also be produced based on light around the mobile device 100. Therefore, in step 230, the touch detector 132 determines whether the mobile device 100 is touched according to the first sensing signal. When the touch detector 132 determines that the mobile device 100 is not touched, the flow is ended, and now the controller 140 deactivates the touch detector 132 to save power.

When the touch detector 132 determines that the mobile device 100 is touched, in step 240, the controller 140 activates the heartbeat detector 134. The heartbeat detector 134 controls the driver 120 to send a second driving signal when being activated. FIG. 3 is a waveform diagram of a first driving signal 301 and a second driving signal 302 according to an embodiment of the invention. A pulse length of the second driving signal 302 of the present embodiment is greater than a pulse length of the first driving signal 301. A frequency of the second driving signal 302 of the present embodiment is also higher than a frequency of the first driving signal 301. For example, the frequency of the first driving signal 301 can be 100 Hz, and the frequency of the second driving signal 302 can be 1 MHz or higher.

In step 250, the life sensor 110 generates a second sensing signal in response to the second driving signal. To be specific, the LED 112 emits a second light signal in response to the second driving signal. The second light signal can also be a red light or an infrared light. The photodiode 114 generates the second sensing signal according to a reflected signal of the second light signal.

In step 260, the heartbeat detector 134 determines whether the second sensing signal includes a heartbeat pattern. Human blood vessel repeatedly dilates and constricts due to the heartbeat, which results in a specific strength variation mode of the second sensing signal. In case of an object without a heartbeat, the second sensing signal does not have such specific strength variation mode. The heartbeat pattern refers to such specific strength variation mode. Whether the second sensing signal includes the heartbeat pattern indicates whether the user holds the mobile device 100. After the detection or determination of the heartbeat detector 134 is completed in the step 260, the controller 140 can deactivate the touch detector 132 and the heartbeat detector 134 to save power. In step 270, the processor 150 executes a corresponding operation according to whether the second sensing signal includes the heartbeat pattern.

The processor 150 is usually in a sleeping state to save power. In an embodiment of the invention, the controller 140 can record a determination result of the heartbeat detector 134. When the processor 150 wakes up due to an event such as an incoming call, a new message or user's operation, etc., the processor 150 can active inquire the controller 140 to learn whether the second sensing signal includes the heartbeat pattern. In another embodiment, the controller 140 actively sends an interrupt signal, etc. to notify the processor 150 after obtaining the determination result of the heartbeat detector 134, and then the processor 150 can inquire the controller 140 to learn whether the second sensing signal includes the heartbeat pattern.

In an embodiment of the invention, when the second sensing signal includes the heartbeat pattern, the corresponding operation in the step 270 is to use a first value to set a hardware component of the mobile device 100. When the second sensing signal does not include the heartbeat pattern, the corresponding operation in the step 270 is to use a second value to set the hardware component, where the first value is different from the second value.

The aforementioned hardware component can be the loudspeaker 160. The first value can be a smaller volume setting value, and the second value can be a larger volume setting value. To decrease the volume of the mobile device 100 when the user holds the mobile device 100 is less likely to disturb the user.

The aforementioned hardware component can be the vibrator 190. The first value can be a smaller vibration setting value, and the second value can be a larger vibration setting value. To decrease the vibration of the mobile device 100 when the user holds the mobile device 100 is less likely to disturb the user.

The aforementioned hardware component can be the transceiver 170. The first value can be a lower wireless signal emitting power, and the second value can be a higher wireless signal emitting power. To decrease the emitting power of the mobile device 100 when the user holds the mobile device 100 can protect the user.

The aforementioned hardware component can be the display 180. The first value can be a brighter backlight brightness setting value, and the second value can be a darker backlight brightness setting value. To enhance a display brightness of the mobile device 100 when the user holds the mobile device 100 avails the user to clearly view display content of the display 180. To decrease the display brightness of the mobile device 100 when the user does not hold the mobile device 100 avails saving power.

In another embodiment, when the second sensing signal includes the heartbeat pattern, the corresponding operation in the step 270 is to send a prompt indicating that the mobile device 100 has a missed call and/or an unread message. In this way, when the user holds the mobile device 100, the user can learn whether there is a missed call and/or an unread message without performing an extra operation.

In another embodiment, when the second sensing signal includes the heartbeat pattern, the corresponding operation in the step 270 is to display the unread message, for example, to automatically display an important unread message. In this way, when the user holds the mobile device 100, the user can immediately read the unread message without performing an extra operation.

In another embodiment, the corresponding operation in the step 270 is to continually execute a certain function of the mobile device 100 in case that the second sensing signal includes the heartbeat pattern, and to pause the function in case that the second sensing signal does not include the heartbeat pattern. For example, the function is to play a movie. Namely, the mobile device 100 continually plays the movie when the user holds the mobile device 100, and pauses the movie when the user does not hold the mobile device 100.

In another embodiment, the corresponding operation in the step 270 is opposite, i.e., a certain function of the mobile device 100 is continually executed in case that the second sensing signal does not include the heartbeat pattern, and the function is paused in case that the second sensing signal includes the heartbeat pattern.

In another embodiment, the corresponding operation in the step 270 is to activate a certain function of the mobile device 100 in case that the second sensing signal includes the heartbeat pattern, and to deactivate the function in case that the second sensing signal does not include the heartbeat pattern. For example, the function is, for example, to wake up the mobile device 100 through a specific operation on the display 180 when the mobile device 100 is in the sleeping state. In this way, when the mobile device 100 is put in a backpack or pocket, since the wake up function is deactivated, the mobile device 100 cannot be waken up due to a miss touch. When the mobile device 100 is held by the user, the wake up function is activated.

In another embodiment, the corresponding operation in the step 270 is opposite, i.e., a certain function of the mobile device 100 is activated in case that the second sensing signal does not include the heartbeat pattern, and the function is deactivated in case that the second sensing signal includes the heartbeat pattern.

In another embodiment, the corresponding operation in the step 270 is to activate a certain function of a peripheral device of the mobile device 100 in case that the second sensing signal includes the heartbeat pattern, and to deactivate the function in case that the second sensing signal does not include the heartbeat pattern. The peripheral device and the mobile device 100 have a communication connection therebetween. For example, the peripheral device can be a wireless headset, a pair of smart glasses, a smart watch or a smart bracelet.

In another embodiment, the corresponding operation in the step 270 is opposite, i.e., a certain function of a peripheral device of the mobile device 100 is activated in case that the second sensing signal does not include the heartbeat pattern, and the function is deactivated in case that the second sensing signal includes the heartbeat pattern. The function is, for example, to send a prompt through sound or vibration in case the mobile device 100 has an incoming call or a new message. When the user holds the mobile device 100, since the mobile device 100 itself can send the prompt in case that there is an incoming call or a new message, the peripheral device is unnecessary to repeat the prompt.

In summary, in the invention, the life sensor is used to replace the conventional capacitive touch sensor. The life sensor of the invention can be fabricated by using the LED and the photodiode, and does not have the disadvantages of the conventional capacitive touch sensor. The life sensor of the invention can correctly detect a touch operation and a holding activity of the user, and misjudgement caused by none heartbeat object is avoided. When the user holds the mobile device, the mobile device of the invention can automatically execute the corresponding operation. In this way, the mobile device can be more intelligent and user-friendly, and the quality of the mobile device is enhanced.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A mobile device, comprising:
a life sensor;
a driver, coupled to the life sensor;
a touch detector, coupled to the life sensor and the driver;
a heartbeat detector, coupled to the life sensor and the driver;
a controller, coupled to the touch detector and the heartbeat detector, and controlling the driver to send a first driving signal, wherein the life sensor generates a first sensing signal in response to the first driving signal; the touch detector determines whether the mobile device is touched according to the first sensing signal; when the touch detector determines that the mobile device is touched, the controller controls the driver to send a second driving signal; the life sensor generates a second sensing signal in response to the second driving signal, and the heartbeat detector determines whether the second sensing signal comprises a heartbeat pattern; and
a processor, coupled to the controller, and executing a corresponding operation according to whether the second sensing signal comprises the heartbeat pattern.

2. The mobile device as claimed in claim 1, wherein the life sensor comprises:
a light-emitting diode, coupled to the driver, and emitting a first light signal in response to the first driving signal, and emitting a second light signal in response to the second driving signal; and
a photodiode, coupled to the touch detector and the heartbeat detector, generating the first sensing signal according to a reflected signal of the first light signal, and generating the second sensing signal according to a reflected signal of the second light signal.

3. The mobile device as claimed in claim 2, wherein a pulse length of the second driving signal is greater than a pulse length of the first driving signal, and a frequency of the second driving signal is higher than a frequency of the first driving signal.

4. The mobile device as claimed in claim 1, wherein the controller activates the touch detector, and the touch detector controls the driver to send the first driving signal when being activated; and when the touch detector determines that the mobile device is touched, the controller activates the heartbeat detector; and the heartbeat detector controls the driver to send the second driving signal when being activated.

5. The mobile device as claimed in claim 1, wherein when the second sensing signal comprises the heartbeat pattern, the corresponding operation is to use a first value to set a hardware component of the mobile device, and when the second sensing signal does not comprise the heartbeat pattern, the corresponding operation is to use a second value to set the hardware component, wherein the first value is different from the second value.

6. The mobile device as claimed in claim 1, wherein when the second sensing signal comprises the heartbeat pattern, the corresponding operation is to send a prompt indicating that the mobile device has a missed call and/or an unread message.

7. The mobile device as claimed in claim 1, wherein when the second sensing signal comprises the heartbeat pattern, the corresponding operation is to display an unread message.

8. The mobile device as claimed in claim 1, wherein the corresponding operation is to continually execute a function of the mobile device in a first case, and to pause the function in a second case, the first case is one of situations that the second sensing signal comprises the heartbeat pattern or does not comprise the heartbeat pattern, and the second case is the other of the situations that the second sensing signal comprises the heartbeat pattern or does not comprise the heartbeat pattern.

9. The mobile device as claimed in claim 1, wherein the corresponding operation is to activate a function of the mobile device in a first case, and to deactivate the function in a second case; the first case is one of situations that the second sensing signal comprises the heartbeat pattern or does not comprise the heartbeat pattern, and the second case is the other of the situations that the second sensing signal comprises the heartbeat pattern or does not comprise the heartbeat pattern.

10. The mobile device as claimed in claim 1, wherein the corresponding operation is to activate a function of a peripheral device having a communication connection with the mobile device in a first case, and to deactivate the function in a second case; the first case is one of situations that the second sensing signal comprises the heartbeat pattern or does not comprise the heartbeat pattern, and the second case is the other of the situations that the second sensing signal comprises the heartbeat pattern or does not comprise the heartbeat pattern.

11. A control method, adapted to a mobile device, comprising:
sending a first driving signal;
generating a first sensing signal in response to the first driving signal;
determining whether the mobile device is touched according to the first sensing signal;
sending a second driving signal when the mobile device is touched;
generating a second sensing signal in response to the second driving signal;
determining whether the second sensing signal comprises a heartbeat pattern; and
executing a corresponding operation according to whether the second sensing signal comprises the heartbeat pattern.

12. The control method as claimed in claim 11, further comprising:
emitting a first light signal in response to the first driving signal;
generating the first sensing signal according to a reflected signal of the first light signal;
emitting a second light signal in response to the second driving signal; and
generating the second sensing signal according to a reflected signal of the second light signal.

13. The control method as claimed in claim 12, wherein a pulse length of the second driving signal is greater than a pulse length of the first driving signal, and a frequency of the second driving signal is higher than a frequency of the first driving signal.

14. The control method as claimed in claim 11, wherein when the second sensing signal comprises the heartbeat pattern, the corresponding operation is to use a first value to set a hardware component of the mobile device; and when the second sensing signal does not comprise the heartbeat pattern, the corresponding operation is to use a second value to set the hardware component; wherein the first value is different from the second value.

15. The control method as claimed in claim 11, wherein when the second sensing signal comprises the heartbeat pattern, the corresponding operation is to send a prompt indicating that the mobile device has a missed call and/or an unread message.

16. The control method as claimed in claim 11, wherein when the second sensing signal comprises the heartbeat pattern, the corresponding operation is to display an unread message.

17. The control method as claimed in claim 11, wherein the corresponding operation is to continually execute a function of the mobile device in a first case, and to pause the function in a second case; the first case is one of situations that the second sensing signal comprises the heartbeat pattern or does not comprise the heartbeat pattern, and the second case is the other of the situations that the second sensing signal comprises the heartbeat pattern or does not comprise the heartbeat pattern.

18. The control method as claimed in claim 11, wherein the corresponding operation is to activate a function of the mobile device in a first case, and to deactivate the function in a second case the first case is one of situations that the second sensing signal comprises the heartbeat pattern or does not comprise the heartbeat pattern, and the second case is the other of the situations that the second sensing signal comprises the heartbeat pattern or does not comprise the heartbeat pattern.

19. The control method as claimed in claim 11, wherein the corresponding operation is to activate a function of a peripheral device having a communication connection with the mobile device in a first case, and to deactivate the function in a second case; the first case is one of situations that the second sensing signal comprises the heartbeat pattern or does not comprise the heartbeat pattern, and the second case is the other of the situations that the second sensing signal comprises the heartbeat pattern or does not comprise the heartbeat pattern.
